(19) United States
(12) Patent Application Publication
(10) Pub. No.: US 2020/0133284 A1
(43) Pub. Date: Apr. 30, 2020

(54) METHOD AND APPARATUS FOR CONTROLLING AUTONOMOUS VEHICLE

(71) Applicant: LG Electronics Inc., Seoul (KR)

(72) Inventors: In HUR, Seoul (KR); Yongsoo PARK, Seoul (KR)

(21) Appl. No.: 16/731,881

(22) Filed: Dec. 31, 2019

(30) Foreign Application Priority Data
Oct. 29, 2019 (KR) 10-2019-0135458

(51) Int. Cl. G05D 1/02; H04W 4/46

(52) U.S. Cl. CPC G05D 1/0221; H04W 4/46; G05D 1/0289; G05D 1/0291

(57) ABSTRACT

At least one of an autonomous vehicle, a user terminal, and a server may be connected or converged with an artificial intelligence (AI) module, an unmanned aerial vehicle (UAV), a robot, an augmented reality (AR) device, a virtual reality (VR) device, a device associated with a 5G service, and the like. A vehicle control method of the present disclosure may include identifying a driving route, identifying whether other vehicle is on the driving route, transmitting a first request message based on information on the driving route, identifying whether a first response message to the first request message is received from the other vehicle, and transmitting, when the first response message is received, a second request message requesting a movement based on the information on the driving route, to the other vehicle based on the first response message.

### CROSS-REFERENCE TO RELATED APPLICATION

This application claims the benefit of Korean Patent Application No. 10-2019-0135458, filed on Oct. 29, 2019, in the Korean Intellectual Property Office, the disclosure of which is incorporated herein in its entirety by reference.

### BACKGROUND

### 1. Field

This disclosure relates to a method and apparatus for controlling a vehicle, and one particular implementation relates to an apparatus for securing a driving route of a vehicle through communication with another vehicle and performing driving based on the driving route, and a control method thereof.

### 2. Description of the Related Art

A vehicle is a device for moving in a direction desired by a user on board. A representative example of the vehicle is a car.

For the convenience of users, vehicles including various types of sensors and electronic devices have been provided. In particular, to increase user's driving convenience, research on an advanced driver assistance system (ADAS) is being actively conducted. Furthermore, developments of autonomous vehicles are being actively made.

In a related art, when an obstacle such as another vehicle is on a route, a vehicle may not travel on the route unless a driver drives the other vehicle to another position.

An autonomous vehicle may autonomously determine a situation and perform driving in a range accepted by a user or a system. With such a generalization of the autonomous vehicle, there is a desire for a method and apparatus for securing a route when a route of a vehicle is blocked by another vehicle.

### SUMMARY

An aspect provides a method and apparatus for securing a driving route of a vehicle by identifying information on a surrounding space of other vehicle on the driving route and requesting the other vehicle to depart from the driving route through vehicle-to-vehicle (V2V) communication.

Another aspect also provides a method and apparatus for securing a driving route of a vehicle by acquiring information on other vehicle located on the driving route through communications between autonomous vehicles and requesting the other vehicle to move based on the acquired information.

Another aspect also provides a method and apparatus for identifying a stopping position to secure a convenience in future driving through communication between other vehicles.

According to an aspect, there is provided a method of controlling a vehicle, the method including identifying a driving route, identifying whether other vehicle is on the driving route, transmitting a first request message based on information on the driving route, identifying whether a first response message to the first request message is received from the other vehicle, and transmitting, when the first response message is received, a second request message requesting a movement based on the information on the driving route, to the other vehicle based on the first response message.

According to another aspect, there is also provided a vehicle including a transceiver configured to perform communication, and a controller configured to control the transceiver, identify a driving route, identify whether other vehicle is on the driving route, transmit a first request message based on information on the driving route, identify whether a first response message to the first request message is received from the other vehicle, and transmit a second request message requesting a movement based on the driving route, to the other vehicle based on the first response message when the first response message is received.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an artificial intelligence (AI) device according to an example embodiment;

FIG. 2 illustrates an AI server according to an example embodiment;

FIG. 3 illustrates an AI system according to an example embodiment;

FIG. 4 is a diagram illustrating an operation of controlling a vehicle in response to information being transmitted and received between an operating device and a 5G network according to an example embodiment;

FIG. 5 is a block diagram illustrating a wireless communication system to which a method according to an example embodiment can be applied;

FIG. 6 is a diagram illustrating an example of a method of transmitting and receiving a signal in a wireless communication system according to an example embodiment;

FIG. 7 is a diagram illustrating a driving route securing and driving method according to an example embodiment;

FIG. 8 is a flowchart illustrating a driving route securing and driving method according to an example embodiment;

FIG. 9 is a diagram illustrating a signal flow based on a driving route securing and driving method according to an example embodiment;

FIG. 10 is a diagram illustrating an operation of a vehicle receiving a movement request from other vehicle according to an example embodiment;

FIG. 11 is a flowchart illustrating a method of securing a driving route according to an example embodiment;

FIG. 12 is a diagram illustrating a method of securing a driving route by sending a movement request to a stationary vehicle when the stationary vehicle is located on a route on which a vehicle is traveling according to an example embodiment;

FIG. 13 is a diagram illustrating a method of securing a driving route by sending a movement request to a movable vehicle when other vehicle blocks a route on which a vehicle is traveling according to an example embodiment;

FIG. 14 is a flowchart illustrating a method of operating a vehicle when an escape message is received from other traveling vehicle while the vehicle is traveling according to an example embodiment;

FIG. 15 is a flowchart illustrating a method of securing a route by setting another route when driving on a predicted route is unavailable according to an example embodiment;

FIG. 16 is a flowchart illustrating a method of selecting a relay vehicle for message transmission according to an example embodiment;

FIG. 17 is a flowchart illustrating a method of determining a vehicle stopping place according to an example embodiment;

FIG. 18 is a flowchart illustrating a method of acquiring route information of a driving route and selecting one route among a plurality of routes based on the route information according to an example embodiment; and

FIG. 19 is a diagram illustrating a operating device according to an example embodiment.

### DETAILED DESCRIPTION

Hereinafter, example embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operations to be performed on the computer or other programmable apparatus to produce a computer implemented process such that the instructions which are executed on the computer or other programmable apparatus provide operations for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to example embodiments of the present disclosure, the term “module” means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card. In addition, a controller mentioned in the embodiments may include at least one processor that is operated to control a corresponding apparatus.

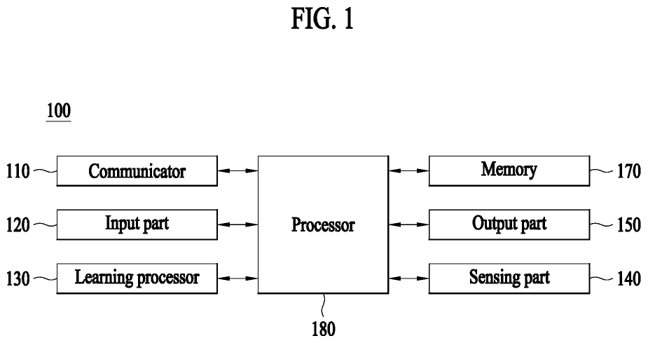

FIG. 1 illustrates an AI device 100 according to an example embodiment of the present disclosure.

The AI device 100 may be realized into, for example, a stationary appliance or a movable appliance, such as a TV, a projector, a cellular phone, a smartphone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, a terminal 100 may include a communicator 110, an input part 120, a learning processor 130, a sensing part 140, an output part 150, a memory 170, and a processor 180, for example.

The communicator 110 may transmit and receive data to and from external devices, such as other AI devices 100a to 100e and an AI server 200, using wired/wireless communication technologies. For example, the communicator 110 may transmit and receive sensor information, user input, learning models, and control signals, for example, to and from external devices.

In this case, the communication technology used by the communicator 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

The input part 120 may acquire various types of data.

In this case, the input part 120 may include a camera for the input of an image signal, a microphone for receiving an audio signal, and a user input part for receiving information input by a user, for example. Here, the camera or the microphone may be handled as a sensor, and a signal acquired from the camera or the microphone may be referred to as sensing data or sensor information.

The input part 120 may acquire, for example, input data to be used when acquiring an output using learning data for model learning and a learning model. The input part 120 may acquire unprocessed input data, and in this case, the processor 180 or the learning processor 130 may extract an input feature as pre-processing for the input data.

The learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

In this case, the learning processor 130 may perform AI processing along with a learning processor 240 of the AI server 200.

In this case, the learning processor 130 may include a memory integrated or embodied in the AI device 100. Alternatively, the learning processor 130 may be realized using the memory 170, an external memory directly coupled to the AI device 100, or a memory held in an external device.

The sensing part 140 may acquire at least one of internal information of the AI device 100 and surrounding environmental information and user information of the AI device 100 using various sensors.

In this case, the sensors included in the sensing part 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

The output part 150 may generate, for example, a visual output, an auditory output, or a tactile output.

In this case, the output part 150 may include, for example, a display that outputs visual information, a speaker that outputs auditory information, and a haptic module that outputs tactile information.

The memory 170 may store data which assists various functions of the AI device 100. For example, the memory 170 may store input data acquired by the input part 120, learning data, learning models, and learning history, for example.

The processor 180 may determine at least one executable operation of the AI device 100 based on information determined or generated using a data analysis algorithm or a machine learning algorithm. Then, the processor 180 may control constituent elements of the AI device 100 to perform the determined operation.

To this end, the processor 180 may request, search, receive, or utilize data of the learning processor 130 or the memory 170, and may control the constituent elements of the AI device 100 so as to execute a predictable operation or an operation that is deemed desirable among the at least one executable operation.

In this case, when connection of an external device is necessary to perform the determined operation, the processor 180 may generate a control signal for controlling the external device and may transmit the generated control signal to the external device.

The processor 180 may acquire intention information with respect to user input and may determine a user request based on the acquired intention information.

In this case, the processor 180 may acquire intention information corresponding to the user input using at least one of a speech to text (STT) engine for converting voice input into a character string and a natural language processing (NLP) engine for acquiring natural language intention information.

In this case, at least a part of the STT engine and/or the NLP engine may be configured with an artificial neural network learned according to a machine learning algorithm. Then, the STT engine and/or the NLP engine may have learned by the learning processor 130, may have learned by the learning processor 240 of the AI server 200, or may have learned by distributed processing of the processors 130 and 240.

The processor 180 may collect history information including, for example, the content of an operation of the AI device 100 or feedback of the user with respect to an operation, and may store the collected information in the memory 170 or the learning processor 130, or may transmit the collected information to an external device such as the AI server 200. The collected history information may be used to update a learning model.

The processor 180 may control at least some of the constituent elements of the AI device 100 in order to drive an application program stored in the memory 170. Moreover, the processor 180 may combine and operate two or more of the constituent elements of the AI device 100 for the driving of the application program.

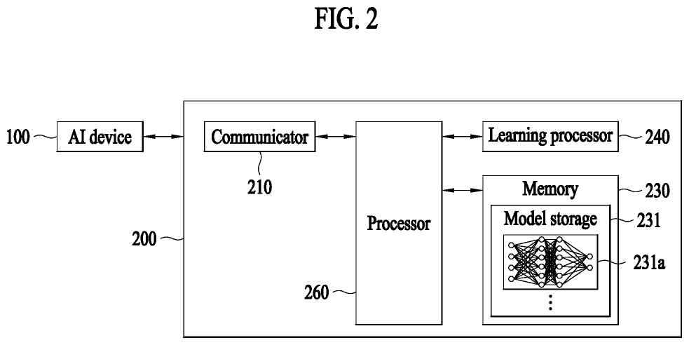

FIG. 2 illustrates the AI server 200 according to an embodiment of the present disclosure.

Referring to FIG. 2, the AI server 200 may refer to a device that causes an artificial neural network to learn using a machine learning algorithm or uses the learned artificial neural network. Here, the AI server 200 may be constituted of multiple servers to perform distributed processing, and may be defined as a 5G network. In this case, the AI server 200 may be included as a constituent element of the AI device 100 so as to perform at least a part of AI processing together with the AI device 100.

The AI server 200 may include a communicator 210, a memory 230, a learning processor 240, and a processor 260, for example.

The communicator 210 may transmit and receive data to and from an external device such as the AI device 100.

The memory 230 may include a model storage 231. The model storage 231 may store a model (or an artificial neural network) 231a which is learning or has learned via the learning processor 240.

The learning processor 240 may cause the artificial neural network 231a to learn learning data. A learning model may be used in the state of being mounted in the AI server 200 of the artificial neural network, or may be used in the state of being mounted in an external device such as the AI device 100.

The learning model may be realized in hardware, software, or a combination of hardware and software. In the case in which a part or the entirety of the learning model is realized in software, one or more instructions constituting the learning model may be stored in the memory 230.

The processor 260 may deduce a result value for newly input data using the learning model, and may generate a response or a control instruction based on the deduced result value.

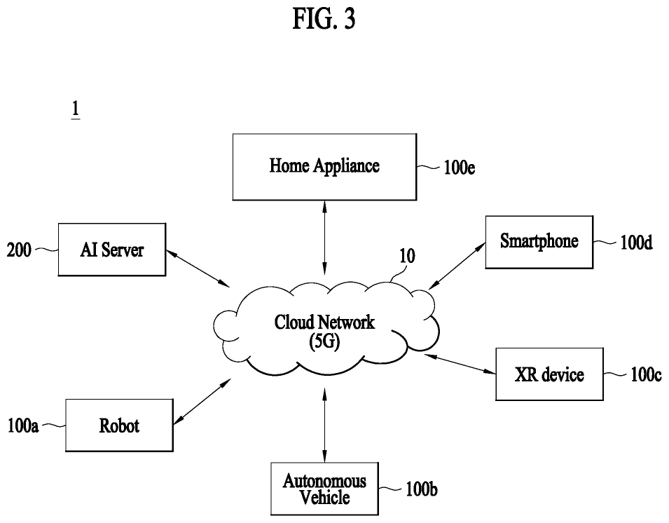

FIG. 3 illustrates an AI system 1 according to an example embodiment.

Referring to FIG. 3, in the AI system 1, at least one of an AI server 200, a robot 100a, an autonomous vehicle 100b, an XR device 100c, a smartphone 100d, and a home appliance 100e is connected to a cloud network 10. Here, the robot 100a, the autonomous vehicle 100b, the XR device 100c, the smartphone 100d, and the home appliance 100e, to which AI technologies are applied, may be referred to as the AI devices 100a to 100e.

The cloud network 10 may constitute a part of a cloud computing infrastructure, or may mean a network present in the cloud computing infrastructure. Here, the cloud network 10 may be configured using a 3G network, a 4G or long term evolution (LTE) network, or a 5G network, for example.

That is, the respective devices 100a to 100e and 200 constituting the AI system 1 may be connected to each other via the cloud network 10. In particular, the respective devices 100a to 100e and 200 may communicate with each other via a base station, or may perform direct communication without the base station.

The AI server 200 may include a server which performs AI processing and a server which performs an operation with respect to big data.

The AI server 200 may be connected to at least one of the robot 100a, the autonomous vehicle 100b, the XR device 100c, the smartphone 100d, and the home appliance 100e, which are AI devices constituting the AI system 1, via the cloud network 10, and may assist at least a part of AI processing of the connected AI devices 100a to 100e.

In this case, instead of the AI devices 100a to 100e, the AI server 200 may cause an artificial neural network to learn according to a machine learning algorithm, and may directly store a learning model or may transmit the learning model to the AI devices 100a to 100e.

In this case, the AI server 200 may receive input data from the AI devices 100a to 100e, may deduce a result value for the received input data using the learning model, and may generate a response or a control instruction based on the deduced result value to transmit the response or the control instruction to the AI devices 100a to 100e.

Alternatively, the AI devices 100a to 100e may directly deduce a result value with respect to input data using the learning model, and may generate a response or a control instruction based on the deduced result value.

Hereinafter, various embodiments of the AI devices 100a to 100e, to which the above-described technology is applied, will be described. Here, the AI devices 100a to 100e illustrated in FIG. 3 may be specific embodiments of AI device 100 illustrated in FIG. 1. A device performing the method in the embodiments may be a computing device including the AI device and, as would be apparent to one skilled in the art, the method of the embodiments of the present disclosure may also be performed by a computing device capable of performing communication with the AI device.

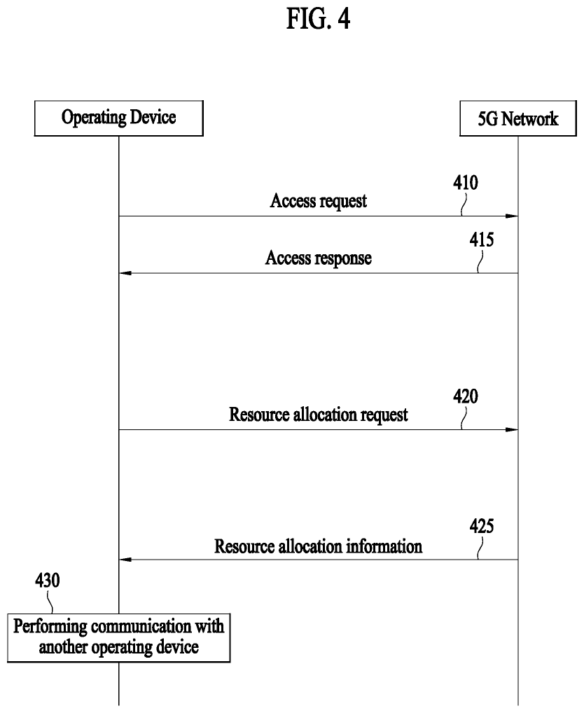

FIG. 4 is a diagram illustrating an operation of controlling a vehicle in response to information being transmitted and received between a computing device and a 5G network according to an example embodiment.

FIG. 4 illustrates a communication method performed between a computing device and a 5G network. In the example embodiment, the computing device may be included in a device to control an overall operation of the vehicle.

In operation 410, the computing device may transmit an access request to the 5G network. The access request may be received by a base station and transmitted on a channel for transmitting an access request. The access request may include information for identifying the computing device.

In operation 415, the 5G network may transmit a response to the access request to the computing device. The response to the access request, for example, an access response, may include identification information to be used when the computing device receives information. Also, the access response may include wireless resource allocation information for transmitting and receiving information of the computing device.

In operation 420, the computing device may transmit a wireless resource allocation request for communicating with another device or a base station based on the received information. The wireless resource allocation request may include at least one of information on the computing device and information on a counterpart node for performing communication.

In operation 425, the 5G network may transmit wireless resource allocation information to the computing device. The wireless resource allocation information may be determined based on at least a portion of the information transmitted in operation 420. For example, information associated with resources allocated to communicate with another computing device and identification information to be used for the corresponding communication may be included in the wireless resource allocation information. For example, communication with another computing device may be performed on a channel for device-to-device communication.

In operation 430, the computing device may perform communication with another computing device based on the received information.

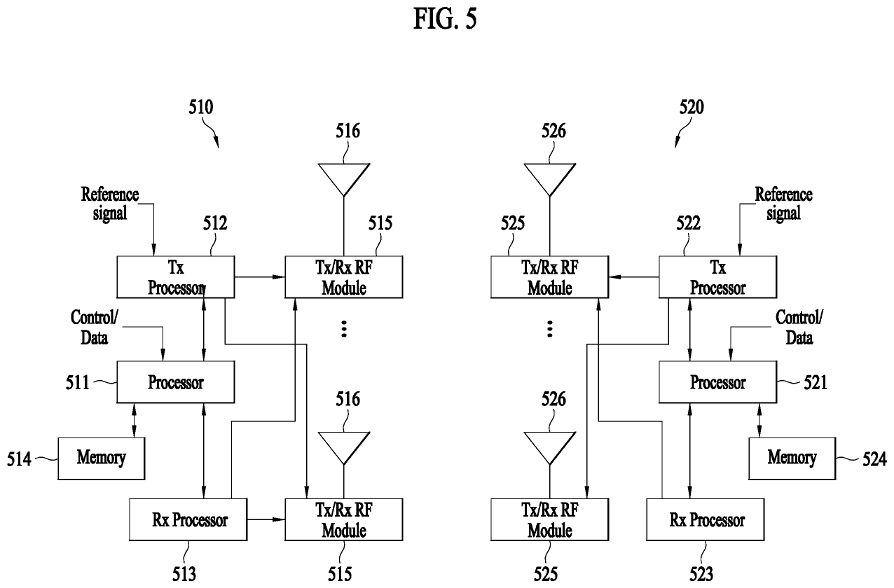

FIG. 5 is a block diagram of a wireless communication system to which a method according to an example embodiment is applicable.

Referring to FIG. 5, an apparatus (an autonomous driving apparatus) including an autonomous driving module may be defined as a first communication device 510, and a processor 511 may perform detailed autonomous driving operations.

A 5G network including another vehicle capable of communicating with the autonomous driving apparatus may be defined as a second communication device 520, and a processor 521 may perform detailed autonomous driving operations.

The 5G network may be expressed as a first communication device, and the autonomous driving apparatus may be expressed as a second communication device.

For example, the first communication device or the second communication device may be a base station, a network node, a Tx terminal, an Rx terminal, a wireless device, a wireless communication device, an autonomous driving apparatus, etc.

For example, a terminal or User Equipment (UE) may include a vehicle, a mobile phone, a smartphone, a laptop computer, a personal digital assistant (PDA), a portable multimedia player (PMP), a navigation, a slate PC, a tablet PC, an ultrabook, a wearable device (e.g., a smartwatch, a smart glass, a head mounted display (HMD)), etc. The HMD may be a display device which can be worn on a user's head. For example, the HMD may be used to realize virtual reality (VR), augmented reality (AR), and mixed reality (MR). Referring to FIG. 5, the first communication device 510 and the second communication device 520 includes processors 511 and 521, memories 514 and 524, one or more Tx/Rx radio frequency (RF) modules 515 and 525, Tx processors 512 and 522, Rx processors 513 and 523, and antennas 516 and 526. A Tx/Rx module may be referred to as transceivers. Each Tx/RX module transmits a signal through the antenna 526. The processor performs the above-described functions, processes, and/or methods. The processor 521 may be related to the memory 524 for storing program codes and data. The memory may be referred to as a computer readable medium. More specifically, in the DL (communication from the first communication device to the second communication), the Tx processor 512 implements various signal processing functions of L1 layer (that is, physical layer). The Rx processor implements various signal processing functions of the L1 layer (that is, physical layer).

The UL (communication from the second communication device to the first communication device) is implemented in the first communication device 510 in a manner similar to the above-description regarding receiver functions in the second communication device 520. Each Tx/Rx module 525 may receive a signal through the antenna 526. Each Tx/Rx module provides a RF subcarrier and information to the Rx processor 523. The processor 521 may be related to the memory 524 for storing program codes and data. The memory may be referred to as a computer readable medium.

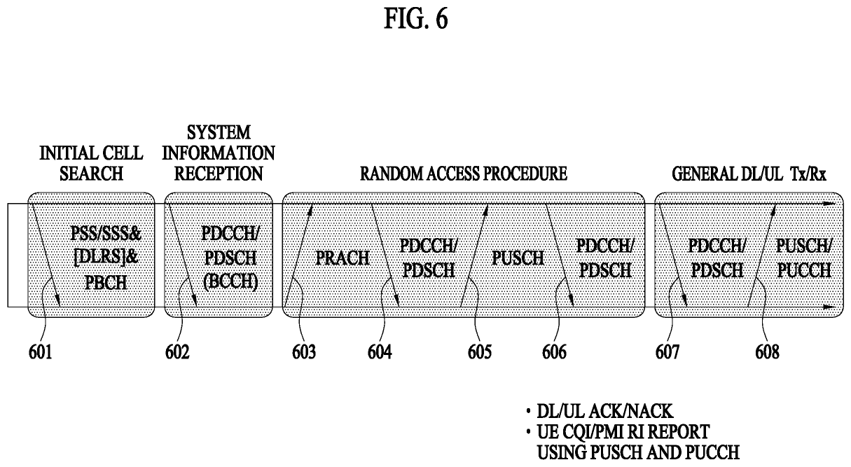

FIG. 6 is a diagram illustrating a method of transmitting and receiving a signal in a wireless communication system according to an example embodiment.

FIG. 6 illustrates an example of a signal transmission/reception method in a wireless communication system.

Referring to FIG. 6, when UE is powered on or enters a new cell, the UE may perform initial cell search such as synchronization with a BS (601). To this end, the UE may receive a primary synchronization channel (P-SCH) and a secondary synchronization channel (S-SCH) from the BS to synchronize with the BS, and may acquire information such as a cell ID. In an LTE system and an NR system, the P-SCH and the S-SCH may be called a primary synchronization signal (PSS) and a secondary synchronization signal (SSS), respectively. After the initial cell search, the UE may acquire broadcast information in the cell by receiving a physical broadcast channel (PBCH) from the BS. Meanwhile, the UE may check the state of a downlink channel by receiving a downlink reference signal (DL RS) during the initial cell search. After completing the initial cell search, the UE may acquire more specific system information by receiving a physical downlink control channel (PDCCH) and a physical downlink shared channel (PDSCH) based on information on the PDCCH (602).

When the UE initially accesses the BS or when there is no radio resource for signal transmission, the UE may perform a random access procedure (RACH) for the BS (603 to 606). To this end, the UE may transmit a specific sequence as a preamble through a physical random access channel (PRACH) (603 and 605), and may receive a random access response (RAR) message for the preamble through the PDCCH and the PDSCH (604 and 606). In the case of contention-based RACH, the UE may additionally perform a contention resolution procedure.

After performing the above-described procedure, the UE may perform, as general uplink/downlink signal transmission procedures, PDCCH/PDSCH reception (607) and physical uplink shared channel (PUSCH)/physical uplink control channel (PUCCH) transmission (208). In particular, the UE may receive downlink control information (DCI) through the PDCCH. The UE may monitor a set of PDCCH candidates at monitoring occasions which are set in one or more control element sets (CORESETs) on a serving cell according to search space configurations. The set of PDCCH candidates to be monitored by the UE may be defined in terms of search space sets, and such a search space set may be a common search space set or a UE-specified search space set. The CORESET is composed of a set of (physical) resource blocks having a time duration of 1 to 3 OFDM symbols. The network may set the UE to have multiple CORESETs. The UE may monitor PDCCH candidates in one or more search space sets. Here, monitoring may refer to attempting to decode PDCCH candidate(s) in a search space. When the UE has succeeded in decoding one of the PDCCH candidates in the search space, the UE may determine that a PDCCH has been detected in a PDCCH candidate, and may perform PDSCH reception or PUSCH transmission based on DCI on the detected PDCCH. The PDCCH may be used to schedule DL transmissions through the PDSCH and UL transmissions through the PUSCH. Here, the DCI on the PDCCH may include downlink assignment (i.e., downlink (DL) grant) including at least modulation, coding format, and resource allotment information associated with a downlink shared channel or uplink (UL) grant including modulation, coding format, and resource allotment information associated with an uplink shared channel.

Referring to FIG. 6, initial access (IA) in the 5G communication system will be further described.

The UE may perform cell search, system information acquisition, beam alignment for initial access, and DL measurement based on an SSB. The SSB may be mixed with a synchronization signal/physical broadcast channel (SS/PBCH) block.

The SSB may be composed of a PSS, an SSS, and a PBCH. The SSB may be composed of four consecutive OFDM symbols, and the PSS, PBCH, SSS/PBCH, or PBCH may be transmitted for each OFDM symbol. Each of the PSS and SSS may be composed of 1 OFDM symbol and 127 subcarriers, and the PBCH may be composed of 3 OFDM symbols and 576 subcarriers.

The cell search may refer to a procedure in which the UE acquires time/frequency synchronization of a cell and detects a cell identifier (ID) (e.g., a physical layer cell ID (PCI)) of the cell. The PSS may be used to detect a cell ID in a cell ID group, and the SSS may be used to detect the cell ID group. The PBCH may be used for SSB (time) index detection and half-frame detection.

There may be 336 cell ID groups, and three cell IDs may exist for each cell ID group. Thus, a total of 1008 cell IDs may exist. Information on a cell ID group, to which a cell ID of a cell belongs, may be provided or acquired through the SSS of the cell, and information on a cell ID among cell IDs of 336 cell ID groups may be provided or acquired through the PSS.

The SSB may be transmitted periodically based on the periodicity of the SSB. An SSB basic period assumed by the UE at the time of initial cell search may be defined as 20 ms. After the cell access, the periodicity of the SSB may be set to one of 5 ms, 10 ms, 20 ms, 40 ms, 80 ms, and 160 ms by a network (e.g., BS).

Next, acquisition of system information (SI) will be described.

The SI may include a master information block (MIB) and multiple system information blocks (SIBs). The SI other than the MIB may be referred to as remaining minimum system Information (RMSI). The MIB may include information/parameters for monitoring the PDCCH which schedules the PDSCH carrying system information block 1 (SIB1), and may be transmitted by the BS through the PBCH of the SSB. The SIB1 may include information on the availability and scheduling (e.g., a transmission period and an SI-window size) of the remaining SIBs (hereinafter, SIBx (x being an integer of 2 or more)). The SIBx may be included in an SI message and may be transmitted through the PDSCH. Each SI message may be transmitted within a time window (i.e., an SI-window) which periodically occurs.

Referring to FIG. 6, random access (RA) in the 5G communication system will be further described.

The random access may be used for various purposes. For example, the random access may be used for network initial access, handover, and UE-triggered UL data transmission. The UE may acquire UL synchronization and UL transmission resources through the random access. The random access may be classified into contention-based random access and contention-free random access. A detailed procedure for the contention-based random access is as follows.

The UE may transmit a random access preamble as an Msg1 of the random access in UL through the PRACH. Random access preamble sequences having two different lengths may be supported. A Long sequence length of 839 may be applied to a subcarrier spacing of 1.25 kHz or 5 kHz, and a short sequence length of 139 may be applied to a subcarrier spacing of 15 kHz, 30 kHz, 60 kHz, or 120 kHz.

When the BS receives the random access preamble from the UE, the BS may transmit a random access response (RAR) message (Msg2) to the UE. The PDCCH which schedules the PDSCH including the RAR may be transmitted by being CRC-masked with a random access (RA) radio network temporary identifier (RNTI) (RA-RNTI). The UE, which has detected the PDCCH masked with the RA-RNTI, may receive the RAR from the PDSCH scheduled by the DCI carried by the PDCCH. The UE may check whether random access response information for the preamble transmitted by the UE, i.e., Msg1, is in the RAR. Whether the random access response information for the Msg1 transmitted by the UE is in the RAR may be determined by whether there is a random access preamble ID for the preamble transmitted by the UE. When there is no response to the Msg1, the UE may retransmit the RACH preamble a predetermined number of times while performing power ramping. The UE may calculate PRACH transmission power for retransmission of the preamble based on the most recent path loss and a power ramping counter.

The UE may transmit, as an Msg3 of the random access, UL transmission through the uplink shared channel based on the random access response information. The Msg3 may include an RRC connection request and an UE identifier. As a response to the Msg3, the network may transmit an Msg4, which may be treated as a contention resolution message in DL. By receiving the Msg4, the UE may enter an RRC-connected state.

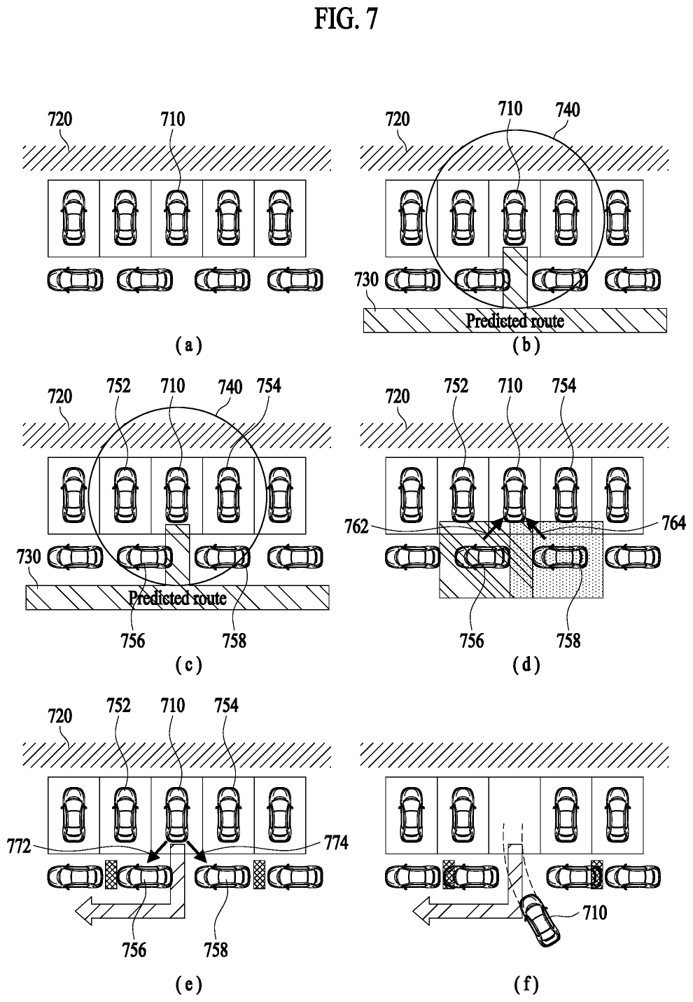

FIG. 7 is a diagram illustrating a driving route securing and driving method according to an example embodiment.

FIG. 7 illustrates an example embodiment in which a vehicle 710 performs driving by identifying a route and securing a driving route through communication with other vehicle.

In part (a) of FIG. 7, the vehicle 710 are surrounded by a wall 720 and other vehicles. The other vehicles may need to move so that the vehicle 710 secures a driving route.

In part (b) of FIG. 7, the vehicle 710 may identify a predicted route 730 for driving. In the example embodiment, the predicted route 730 may be identified based on at least one of a current position of the vehicle 710 and a position of a destination. Also, the vehicle 710 may identify the predicted route 730 based on intermediate destination information. The predicted route 730 may include one or more routes.

In the example embodiment, the vehicle 710 may transmit an escape message including at least one of predicted route information, position information, and identification information of the vehicle 710 to other node. The vehicle 710 may broadcast the information as indicated by a circle 740. The vehicle 710 may broadcast the information on a channel allocated for broadcasting. The channel for broadcasting may be identified based on the identification information of the vehicle 710. The vehicle 710 may transmit the escape message on a channel for sidelink. The channel for sidelink may be identified by the vehicle 710 before driving. Also, the escape message may include information on whether a movement of the other vehicle is available and a nearby street information request to be sent to the other vehicle.

In part (c) of FIG. 7, a first vehicle 752 and a second vehicle 754 may receive an escape request message. The first vehicle 752 and the second vehicle 754 may identify whether the first vehicle 752 and the second vehicle 754 are located on the predicted route of the vehicle 710 based on the received escape request messages, respectively. In the example embodiment, the first vehicle 752 and the second vehicle 754 are not located on the identified route and thus, may not transmit a separate message to the vehicle 710.

In another example embodiment, the first vehicle 752 and the second vehicle 754 may provide information on a distance from a nearby object to the vehicle 710 to assist the vehicle 710 in determining the predicted route. The vehicle 710 may determine the predicted route 730 based on the received information.

A third vehicle 756 and a fourth vehicle 758 may receive escape request messages. The third vehicle 756 and the fourth vehicle 758 may identify whether the third vehicle 756 and the fourth vehicle 758 are located on the predicted route 730 based on the received messages, respectively. In the example embodiment, each of the third vehicle 756 and the fourth vehicle 758 may be a vehicle capable of autonomous driving and may identify its surrounding information based on the received message.

In part (d) of FIG. 7, each of the third vehicle 756 and the fourth vehicle 758 may identify a movable range and transmit information 762, 764 on the movable range to the vehicle 710. In the example embodiment, the information on the movable range may include information on a movable distance based on coordinates of the corresponding vehicle. The information on the movable range may also include information on a distance to which each of the third vehicle 756 and the fourth vehicle 758 is to move such that the vehicle 710 travels along the predicted route 730. In this instance, the transmitted information 762, 764 may include at least one of identification information, position information, and information on a movable range of the corresponding vehicle.

In part (e) of FIG. 7, based on received information and predicted route information, the vehicle 710 may identify a driving route to travel. In the example embodiment, a driving route may be determined to move rearward and then to the left. To drive based on the driving route, the vehicle 710 may transmit movement request messages to the third vehicle 756 and the fourth vehicle 758 as indicated by arrows 772 and 774. In the example embodiment, the movement request message may include at least one of identification information, moving direction information, moving distance information, and security information of a vehicle to move. In response to the movement request message being received, each of the third vehicle 756 and the fourth vehicle 758 may move based on the received information and identify whether to perform a movement corresponding to the message based on the security information before performing the movement.

In part (f) of FIG. 7, the vehicle 710 may perform a movement based on the corresponding route after the third vehicle 756 and the fourth vehicle 758 move. After the movement, the vehicle 710 may transmit information on a movement result to the third vehicle 756 and the fourth vehicle 758. When the information on the movement result is received, each of the third vehicle 756 and the fourth vehicle 758 may move to an original position based on the received message.

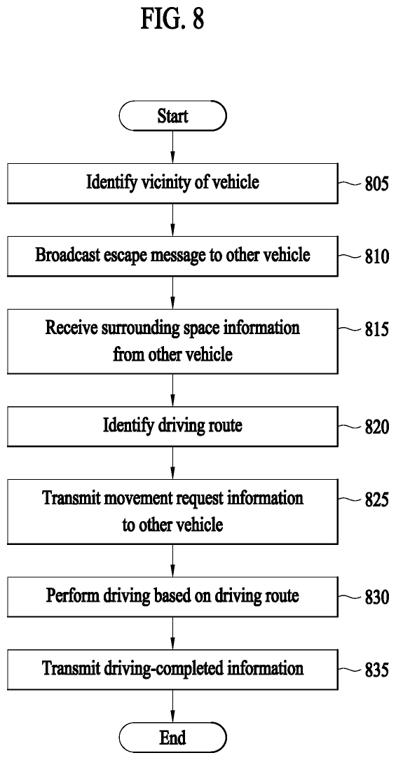

FIG. 8 is a flowchart illustrating a driving route securing and driving method according to an example embodiment.

FIG. 8 illustrates an example of a vehicle performing driving by identifying surrounding information and securing a driving route through communication with other vehicle when the driving route is blocked by the other vehicle.

In operation 805, a vehicle may check a vicinity of the vehicle based on a predicted driving route. The vehicle may identify whether other vehicle is located on the predicted driving route. The vehicle may identify objects located around the vehicle through a sensor and identify whether a movable vehicle is present among the objects. Also, the vehicle may identify objects located on the predicted driving route and identify whether a movable object is present among the objects. When an object is absent on the predicted driving route of the vehicle, the vehicle may travel along the predicted driving route. When the other vehicle is located on the predicted driving route of the vehicle, the vehicle may not travel along the predicted driving route, and may transmit and receive information to and from the other vehicle to secure a driving route.

In operation 810, the vehicle may transmit an escape message to the other vehicle. The vehicle may broadcast the escape message. The escape message may be transmitted on a channel for transmitting a broadcast message for vehicle-to-vehicle (V2V) communication. The escape message may include at least one of identification information, position information, size information, steering range information, direction information, and predicted driving route information of the vehicle. The predicted driving route information may include information on one or more predicted routes.

In operation 815, the vehicle may receive a response message to the escape message from the other vehicle. The response message may include information on a surrounding space of the other vehicle. In the example embodiment, the other vehicle located on the driving route among nearby vehicles may transmit a response message to the vehicle. The information on the surrounding space may include information on a movable range of the other vehicle. For example, the information on the surrounding space may include information on a range to which the other vehicle is to move for traveling of the vehicle. The other vehicle may identify the information on the surrounding space using a sensor of the other vehicle and transmit the information to the vehicle.

In operation 820, the vehicle may identify a driving route based on the received information and the predicted driving route. For example, the vehicle may identify a driving route along which driving is allowed when the other vehicle having transmitted the response message moves, among predicted driving routes as a driving route. In the example embodiment, the vehicle may identify a route to be secured through movements of a minimum number of other vehicles among predicted driving routes, as a driving route. Also, in the example embodiment, the vehicle may identify other vehicle to move and requested movement information of the other vehicle based on the identified driving route.

In operation 825, the vehicle may transmit movement request information to the other vehicle based on one of the information identified in the previous operation. The vehicle may transmit the movement request information including at least one of moving direction information and moving distance information to the vehicle requested to move. Also, the movement request information may include at least one of information on a vehicle transmitting information, information on a vehicle receiving the information, information on a requested moving direction, and information on a requested moving distance. When the movement request information is received, the other vehicle may perform a movement based on the received information such that the vehicle secures the driving route.

In operation 830, the vehicle may identify that the other vehicle moves based on the movement request information, and then perform driving based on the driving route. In the example embodiment, the vehicle may identify whether the other vehicle is located on the driving route and perform driving when the other vehicle or an object is absent and the driving is available.

In operation 835, when the vehicle traveled past a position in which the other vehicle had been located on the driving route, the vehicle may transmit driving-completed information to the other vehicle in accordance with the traveling. The driving-completed information may include at least one of information on the vehicle, information on the other vehicle, previous movement request information, and driving time information. In the example embodiment, the other vehicle may move to an original position based on the driving-completed information.

As such, when the other vehicle is located on the predicted driving route of the vehicle, the vehicle may transmit related information to the other vehicle, receive information on a movable range from the other vehicle, and send a request for securing a route to the other vehicle based on the received information. The vehicle may secure the driving route, perform driving based on the secured driving route, and provide information indicating that the driving is completed to the other vehicle such that the other vehicle returns to the original position. Through this, the vehicle may secure the driving route by moving the other vehicle through the V2V communication without need to use a separate central control unit.

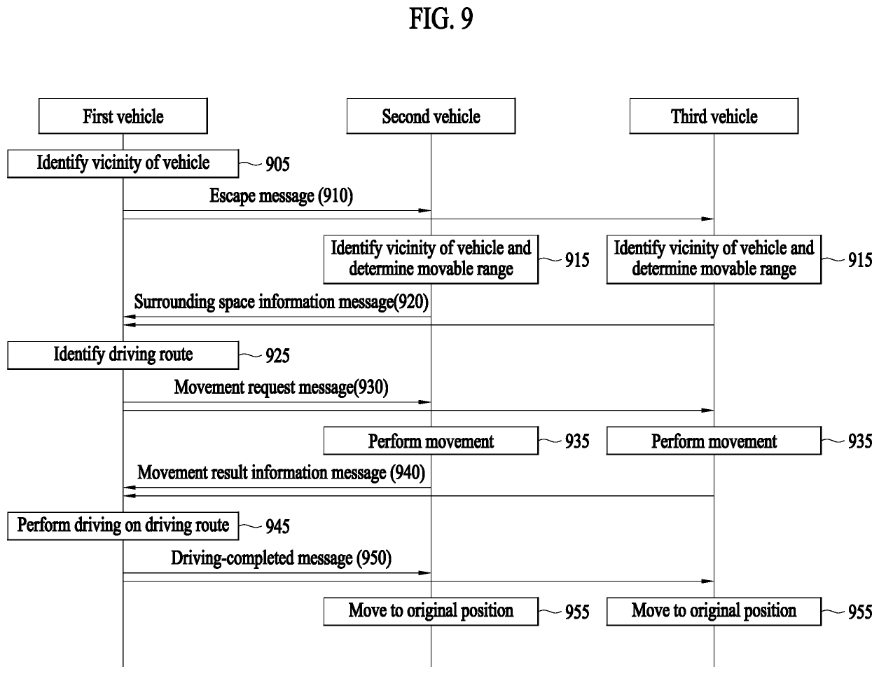

FIG. 9 is a diagram illustrating a signal flow based on a driving route securing and driving method according to an example embodiment.

FIG. 9 illustrates an example in which a first vehicle secures a route by communicating with a second vehicle and a third vehicle located on a predicted driving route in order to perform driving.

In operation 905, the first vehicle may check a vicinity of the first vehicle based on a predicted driving route. The first vehicle may identify whether other vehicle is located on the predicted driving route through a sensor. In the example embodiment, the second vehicle and the third vehicle may be located on the predicted driving route. Although not shown, other vehicles may also be located in the vicinity of the first vehicle and not be located on the predicted driving route.

In operation 910, the first vehicle may transmit an escape message to other vehicle. The escape message may be transmitted to the other vehicle through broadcasting. The escape message may include at least one of identification information of the first vehicle, predicted route information of the first vehicle, position information of the first vehicle, and direction information of the first vehicle. Transmission power of the escape message may be determined based on surrounding information identified by the first vehicle. When numerous vehicles are located on the predicted driving route, the transmission power of the escape message may increase.

In operation 915, each of the second vehicle and the third vehicle may check a vicinity of the corresponding vehicle and determine a movable range based on the received escape message. Also, based on the received escape message, each of the second vehicle and the third vehicle may check the vicinity of the corresponding vehicle and determine the movable range in consideration of a space to be secured by the corresponding vehicle such that the first vehicle travels on the predicted driving route. In a case of other vehicle which is not located on the predicted driving route, the escape message may be neglected even though the other vehicle receives the escape message.

In operation 920, each of the second vehicle and the third vehicle may transmit a surrounding space information message to the first vehicle based on information identified in the previous operation. The surrounding space information message may include at least one of identification information of a vehicle receiving a message, identification information of a vehicle transmitting the message, position information of the vehicle transmitting the message, direction information in which the vehicle transmitting the message is located, and information on a movable range of the vehicle transmitting the message. The first vehicle may receive the surrounding space information message based on the identification information of the vehicle receiving the message.

In operation 925, the first vehicle may identify a driving route based on the received message. The first vehicle may identify, as the driving route, a route that is to be secured by moving the second vehicle and the third vehicle among predicted driving routes based on the received message. In the example embodiment, the predicted driving route may include at least one route. The first vehicle may identify a route to travel based on the message received from the other vehicle. Also, the first vehicle may identify movement information of the other vehicle to move based on the identified driving route. The movement information may include information on a movement to be performed by the other vehicle for the first vehicle to travel on the driving route, and a moving distance and a moving direction of the other vehicle. The movement information may also include information on a position to which the other vehicle is to move such that the first vehicle travels on the driving route.

In operation 930, the first vehicle may transmit a movement request message to each of the second vehicle and the third vehicle based on the identified movement information. The movement request message may include at least one of information on a vehicle to receive a message, information on a vehicle transmitting the message, and movement information on a movement to be performed by a vehicle receiving the message. The movement request message may be transmitted to the other vehicle through broadcast or unicast. When the movement request message is transmitted through the broadcast, the corresponding message may include identification information of each vehicle and request movement information corresponding to the identification information. In response to the movement request message being received, each of the second vehicle and the third vehicle may perform a movement based on the requested movement information corresponding to the identification information of itself in the corresponding message.

In operation 935, each of the second vehicle and the third vehicle receiving the movement request message may perform the movement based on the received movement request message.

In operation 940, each of the moved vehicles may transmit a movement result information message to the first vehicle. The movement result information message may include identification information of a vehicle transmitting a message, identification information of a vehicle receiving the message, and information on a movement result of the vehicle transmitting the message. The information on the movement result may include at least one of whether the movement is successful, information on a time in which the vehicle is allowed to stay at the corresponding position after the movement, and information on a position of the vehicle after the movement.

In operation 945, the first vehicle may perform driving on the driving route based on the received movement result information message. In the example embodiment, the second vehicle and the third vehicle may move from positions on the driving route to other positions, so that the driving route is secured. Thus, the first vehicle may perform the driving on the driving route.

In operation 950, when the first vehicle traveled past the positions in which the second vehicle and the third vehicle had been located, the first vehicle may transmit a driving-completed message to at least one of the second vehicle and the third vehicle in accordance with the traveling. The driving-completed message may include identification information of a vehicle transmitting the message, identification information of a vehicle receiving the message, information on a position of the vehicle having transmitted the message, and information indicating that the vehicle having received the message is to return to an original position.

In operation 955, the second vehicle and the third vehicle may move to original positions based on the received message. An operation of returning to original positions may be performed by the second vehicle and the third vehicle simultaneously, and may be performed sequentially when ordinal operations are required.

As such, a vehicle may secure a driving route through a message exchange with other vehicle and perform driving on the driving route. Through this, the vehicle may smoothly perform the driving even when the driving route is blocked by the other vehicle.

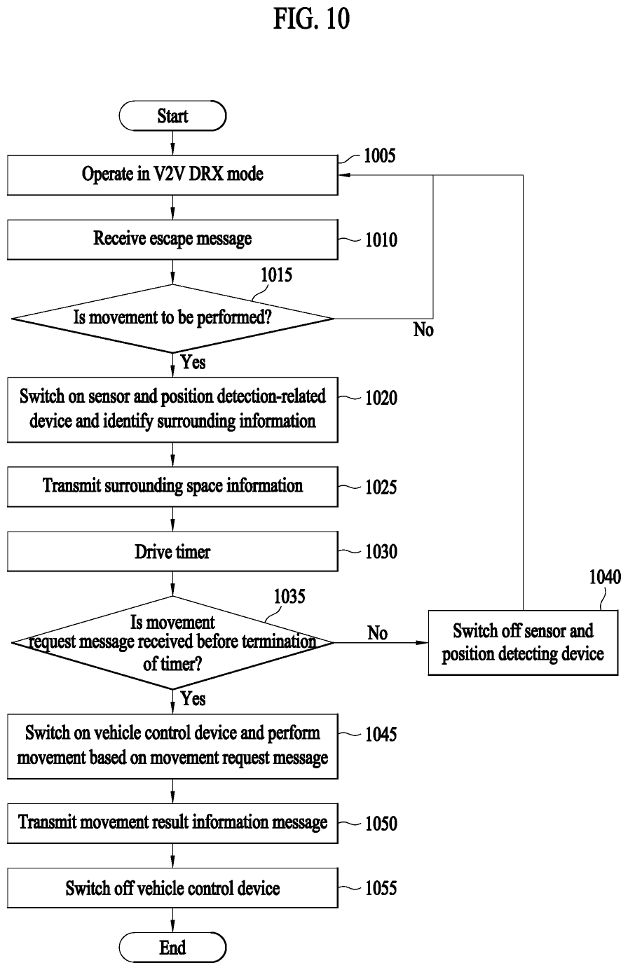

FIG. 10 is a flowchart illustrating an operation of a vehicle receiving a movement request from other vehicle according to an example embodiment.

FIG. 10 illustrates an example embodiment related to an operation of a vehicle receiving an escape message from other vehicle.

In operation 1005, a vehicle may operate in a discontinuous reception (DRX) mode for communication related to V2X communication. Because the vehicle is located in a stationary state, the vehicle may operate in the DRX mode to reduce power consumption and prevent an unnecessary operation related to V2X message reception.

In operation 1010, the vehicle may receive the escape message transmitted from the other vehicle. In the example embodiment, the escape message may be transmitted through broadcasting. The escape message may include at least one of identification information of the other vehicle and information on a predicted route of the other vehicle.

In operation 1015, the vehicle may identify whether a movement is to be performed, based on the received message. For example, when the vehicle is located on the predicted route, the vehicle may determine that the movement is to be performed based on the information on the predicted route. When the movement is not to be performed, the vehicle may continually operate in the DRX mode as in operation 1005 instead of transmitting a separate response message. Although the movement is not to be performed, a response message may also be transmitted to the vehicle having transmitted the escape message.

When it is determined that the movement is to be performed, the vehicle may identify surrounding information by operating at least one of a sensor and a position detection-related device in operation 1020. In the example embodiment, since the vehicle is stationary, a separate sensor may be in an off state. Thus, when it is determined that the movement is to be performed, the sensor may be switched on to identify the surrounding information. In this instance, the identified surrounding information may include information on a movable range for providing a space in which the vehicle having transmitted the escape message is to be driven on the predicted driving route.

In operation 1025, the vehicle may transmit information on a surrounding space to other vehicle based on the identified information. When transmitting the information, at least one of identification information on the vehicle transmitting the information and identification information on a vehicle receiving the information may be transmitted along therewith. In the example embodiment, the transmitted information may include information on a space between the vehicle and the surrounding space and thus, may be referred to as a gap report message. Also, in the example embodiment, the vehicle may operate in a usual mode for receiving a message instead of the DRX mode to wait for receiving a message from the other vehicle after transmitting the gap report message.

In operation 1030, the vehicle may drive a timer in response to message transmission. A timer value may be set as a specific value or determined based on the information transmitted in the escape message. For example, when the escape message is transmitted through relaying of other nodes, the timer may be set to be relatively long. As such, the escape message may include information for setting the timer value. However, the vehicle may drive the timer only in the corresponding range based on a preset maximum timer value. This is for preventing the vehicle from indefinitely waiting for a message in an on state, which may lead to a waste of power.

In operation 1035, the vehicle may identify whether the movement request message is received before the timer is terminated. When the timer is terminated without receiving the message, the vehicle may switch off the sensor and the position detecting device and operate in the DRX mode in operation 1040.

When the movement request message is received before termination of the timer, the vehicle may switch on a vehicle control device and perform a movement based on the movement request message in operation 1045.

In operation 1050, the vehicle performing the movement may transmit a movement result information message to the other vehicle. Thereafter, the vehicle may be on standby until a message indicating to return to an original position is received from the other vehicle having performed driving. When the message is received from the other vehicle, the vehicle may return to the original position. In operation 1055, the vehicle having returned to the original position may switch off the vehicle control device. Thereafter, the vehicle may terminate an operation or perform an operation, starting from operation 1005.

As such, a vehicle may receive an escape request message and a movement request message from other vehicle in a stationary state. The vehicle may operate to reduce power consumption in the stationary state. Thus, the vehicle may change a communication mode or perform switching-on/off of a sensor or a control device, thereby preventing waste of power.

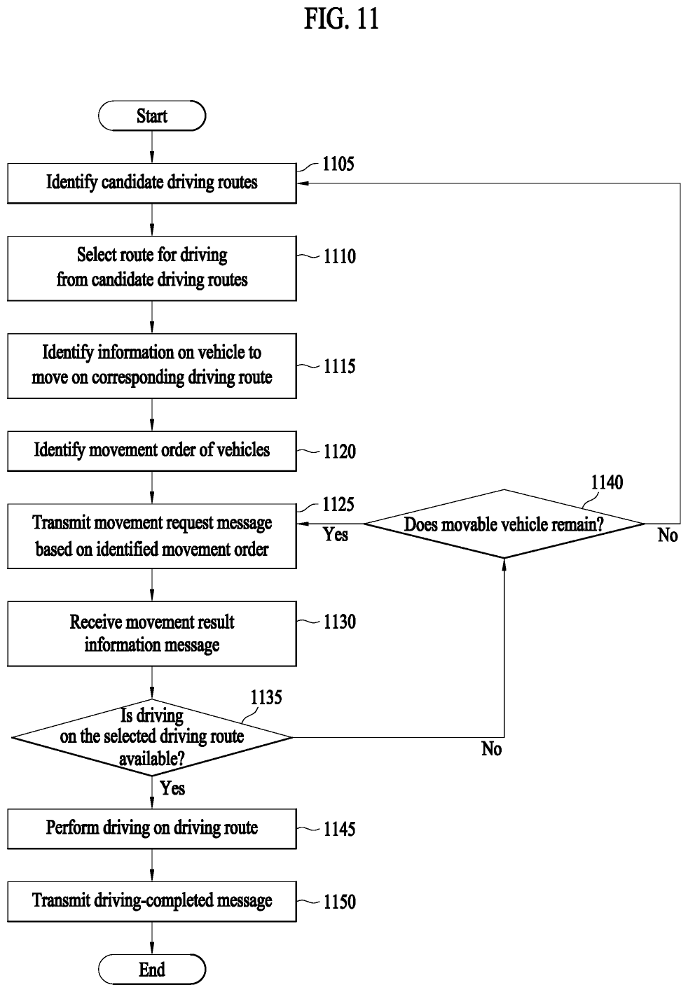

FIG. 11 is a flowchart illustrating a method of securing a driving route according to an example embodiment.

FIG. 11 illustrates an example related to a method of securing a driving route by instructing a movement when a plurality of other vehicles is located on a route on which a vehicle is to travel.

In operation 1105, a vehicle may identify one or more candidate driving routes. In the example embodiment, the candidate driving routes may include different routes for reaching one destination. The vehicle may identify the candidate driving routes based on map information.

In operation 1110, the vehicle may select a route for driving from candidate driving routes. The selected route may include at least one of a route satisfying a shortest distance, a route satisfying a minimum time, and a route selected by a user. Also, the vehicle may identify a vehicle located between candidate routes and select a driving route based on a result of the identifying. For this, the vehicle may transmit an escape message including candidate driving route information and receive a response from other vehicle, thereby identifying a vehicle located on a candidate route. The vehicle may select a route that minimizes a movement of the other vehicle as a driving route.

In operation 1115, the vehicle may identify information on a vehicle to move on the selected driving route. The vehicle may identify the information on the vehicle to move on the selected driving route based on information included in a message received from the other vehicle in response to an escape request message transmitted to the other vehicle. The information on the vehicle to move may include at least one of information for identifying a target vehicle for movement, a position of the target vehicle for movement, a movable range of the target vehicle for movement, and direction information of the target vehicle for movement.

In operation 1120, the vehicle may identify a movement order of vehicles to move to secure a driving route. The movement may be restricted among other vehicles. Also, when a plurality of other vehicles is to move, a movement efficiency may be determined based on the movement order. The vehicle may generate a list of other vehicles to move, and manage the list to correspond to the movement order.

In operation 1125, the vehicle may transmit movement request messages to the vehicles to move based on the identified movement order. In the example embodiment, the movement request messages may be transmitted to a plurality of vehicles simultaneously or in sequence. The movement request message may include at least one of information on other vehicle instructed to move, moving distance information, moving direction information, moved position information, and movement order information. The other vehicle receiving the movement request message may perform a movement based on the information included in the movement request message.

In operation 1130, the vehicle may receive a movement result information message from the other vehicle performing the movement. The vehicle may identify a movement result of the other vehicle based on the received message. The movement result information message may include at least one of information on the other vehicle performing the movement and information on a position after the movement.

In operation 1135, the vehicle may identify whether driving on the selected driving route is available in response to the other vehicle moving. When the driving on the selected driving route is unavailable, the vehicle may identify whether a movable vehicle remains in operation 1140. When the movable vehicle remains, the vehicle may transmit a movement request message to the remaining movable vehicle in operation 1125. When the movable vehicle does not remain and the driving on the selected driving route is unavailable, the vehicle may identify candidate driving routes in operation 1105, and then select a different driving route.

When the driving on the selected driving route is available, the vehicle may perform the driving on the driving route in operation 1145.

When the driving with respect to a position of the other vehicle on the driving route is completed, the vehicle may transmit a driving-completed message to the other vehicle in operation 1150. The other vehicle may move to an original position in response to the driving-completed message being received.

As such, by selecting a driving route from a plurality of candidate driving routes and moving a plurality of other vehicles in sequence, a vehicle may efficiently select a route and secure a driving route of the vehicle without control of a separate central control unit.

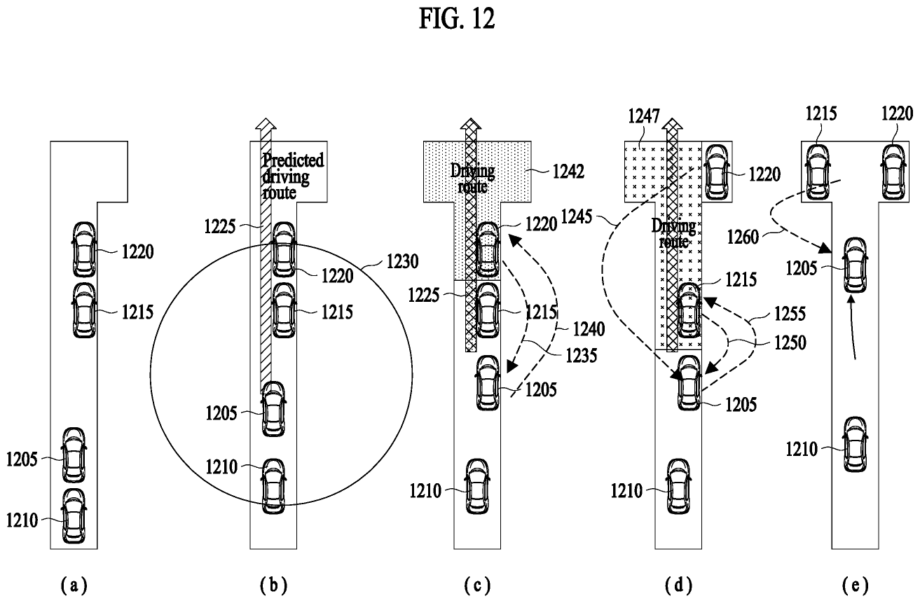

FIG. 12 is a diagram illustrating a method of securing a driving route by sending a movement request to a stationary vehicle when the stationary vehicle is located on a route on which a vehicle is traveling according to an example embodiment.

Referring to FIG. 12, a first vehicle 1205 and a second vehicle 1210 are traveling, and a third vehicle 1215 and a fourth vehicle 1220 may be stationary. FIG. 12 illustrates an example embodiment related to a method of securing driving routes of the first vehicle 1205 and the second vehicle 1210.

In part (a) of FIG. 12, the first vehicle 1205 may identify that a driving route ahead is blocked by the third vehicle 1215 and the fourth vehicle 1220 through a sensor.

In part (b) of FIG. 12, a vehicle may transmit an escape message 1230 including information on a predicted driving route 1225 to other vehicle. The escape message 1230 may be transmitted through a broadcast channel.

In part (c) of FIG. 12, the fourth vehicle 1220 receiving the escape message 1230 may transmit a response message 1235 including information on a movable range 1242 to the first vehicle 1205. Based on the received response message 1235, the first vehicle 1205 may transmit a movement request message 1240 to the fourth vehicle 1220 to secure a driving route. The movement request message 1240 may include at least one of a moving distance, a moving direction, and information on a position after a movement in association with a movement of the fourth vehicle 1220. In the example embodiment, the information on the movable range may be identified based on at least one of map information and information acquired through the sensor of the vehicle.

In part (d) of FIG. 12, based on the movement request message 1240, the fourth vehicle 1220 may move to a position for the first vehicle 1205 to secure the driving route, and transmit a movement-completed message 1245 to the first vehicle 1205. The movement-completed message 1245 may include information indicating the movement is completed based on the movement request message. Thereafter, the first vehicle may receive a response message 1250 including information on a movable range 1247 from the third vehicle 1215. The first vehicle may transmit a movement request message 1255 to the third vehicle 1215 to secure the driving route based on the received information. The movement request message 1255 may include at least one of a moving distance, a moving direction, and information on a position after a movement in association with the movement of the third vehicle 1215.

In part (e) of FIG. 12, the third vehicle 1215 may move to a position for the first vehicle 1205 to secure the driving route, and transmit a movement-completed message 1260 to the first vehicle 1205. When the movement-completed message 1260 is received, the first vehicle 1205 may identify that the driving route is secured and perform the driving on the driving route. Also, the first vehicle 1205 may identify information on a driving route of the second vehicle 1210. When the driving route of the second vehicle 1210 corresponds to the driving route of the first vehicle 1205, the first vehicle 1205 may transmit, to the second vehicle 1210, a message including information indicating that the driving route is secured after the driving route is secured. The second vehicle 1210 may receive the message and perform driving on the corresponding driving route. Also, in the example embodiment, the second vehicle 1210 may provide a user with information indicating that the driving route of the second vehicle 1210 corresponds to the driving route of the first vehicle 1205. The information may include route information of the first vehicle 1205 and the second vehicle 1210, and information indicating that the driving is to be performed based on the corresponding driving route.

For ease and convenience of description, message transmission and reception is explained in an order illustrated in the drawings. However, embodiments are not limited thereto. Depending on an example, the response messages 1235 and 1250 may be received in the first vehicle 1205, the first vehicle 1205 may determine a movement order of other vehicles, and the movement request messages 1240 and 1255 may be respectively transmitted to the fourth vehicle 1220 and the third vehicle 1215 based on the movement order.

As such, a vehicle may secure a driving route through message transmission and reception between vehicles even when other vehicles block a route on which the vehicle is traveling.

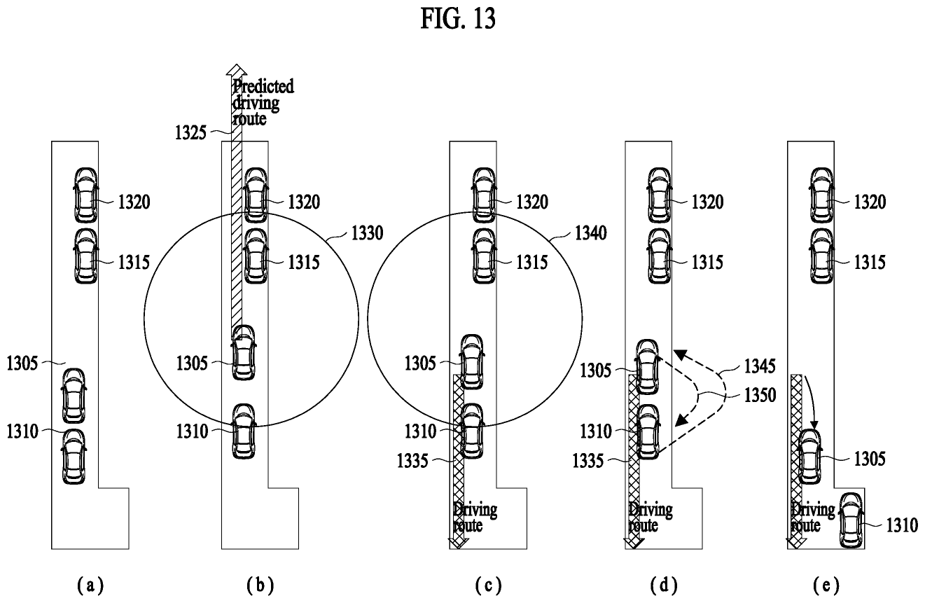

FIG. 13 is a diagram illustrating a method of securing a driving route by sending a movement request to a movable vehicle when other vehicle blocks a route on which a vehicle is traveling according to an example embodiment.

Referring to FIG. 13, a first vehicle 1305 and a second vehicle 1310 are traveling, and a third vehicle 1315 and a fourth vehicle 1320 may be stationary. The third vehicle 1315 and the fourth vehicle 1320 may be incapable of performing autonomous driving. FIG. 13 illustrates an example embodiment related to a method of securing a driving route of the first vehicle 1305.

In part (a) of FIG. 13, the first vehicle 1305 may identify that a driving route ahead is blocked by the third vehicle 1315 and the fourth vehicle 1320 through a sensor.

In part (b) of FIG. 13, a vehicle may transmit an escape message 1330 including information on a predicted driving route 1325 to other vehicle. The escape message 1330 may be transmitted through a broadcast channel. In the example embodiment, each of the third vehicle 1315 and the fourth vehicle 1320 may be a vehicle incapable of performing autonomous driving, and may be a vehicle capable of performing the autonomous driving but performing a movement restricted by a user. The first vehicle 1305 may not receive a response message to an escape message is not received or may receive a message indicating that a movement is unavailable from at least one of the third vehicle 1315 and the fourth vehicle 1320. In this case, the first vehicle 1305 may identify that driving on the predicted driving route is unavailable.

In part (c) of FIG. 13, the first vehicle 1305 may transmit an additional escape message 1340 including information on a corrected driving route 1335. The escape message 1340 may also be transmitted through a broadcast channel. The escape message 1340 may include the information on the corrected driving route 1335.

In part (d) of FIG. 13, the second vehicle 1310 receiving the escape message may provide a user with information indicating that the driving route of the second vehicle 1310 is different from the driving route 1335 of the first vehicle 1305. The information may include at least one of information on a driving route of each vehicle and information inquiring whether to approve a change of a driving route. When the change is approved, the second vehicle 1310 may transmit a response message 1345 including information on a movable range to the first vehicle 1305. The first vehicle 1305 receiving the response message 1345 may transmit a movement request message 1350 to the second vehicle 1310 to secure the driving route 1335.

In part (e) of FIG. 13, the second vehicle 1310 receiving the movement request may perform a movement such that the first vehicle 1305 secures the driving route. The first vehicle 1305 may perform a movement corresponding to the driving route 1335. The first vehicle 1305 may perform the movement on the corresponding driving route and transmit information on a completion of the movement to the second vehicle 1310. The second vehicle 1310 receiving the information on the completion of the movement may correct the driving route based on the information and perform driving.

As such, when a route of a traveling vehicle is blocked by an unmovable vehicle, the traveling vehicle may secure a driving route by changing a route and requesting another traveling vehicle to move, so as to perform driving with increased efficiency.

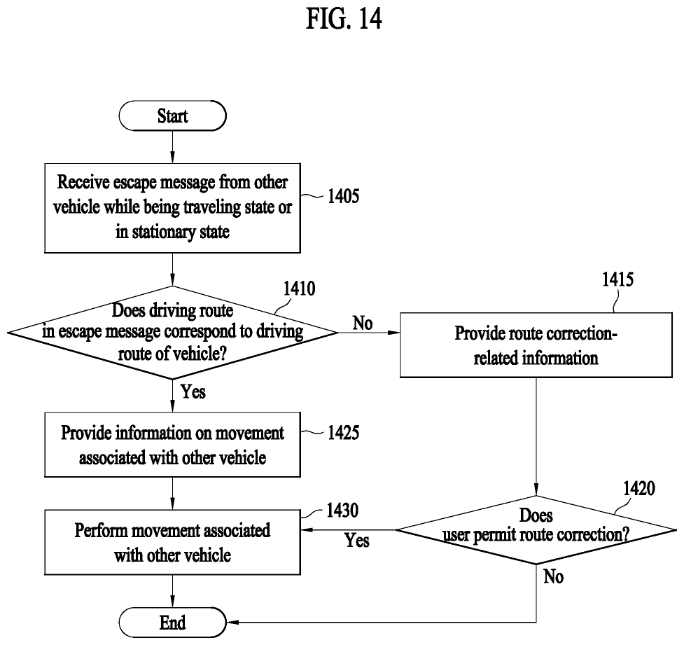

FIG. 14 is a flowchart illustrating a method of operating a vehicle when an escape message is received from other traveling vehicle while the vehicle is traveling according to an example embodiment.

FIG. 14 illustrates an example embodiment related to a method in which a vehicle performing driving receives an escape message from other vehicle, provides information to a user based on the escape message, and performs a vehicle control.

In operation 1405, a vehicle may receive an escape message transmitted from other vehicle while the vehicle is traveling or in a stationary state. The escape message may include information on the other vehicle and information on a driving route of the other vehicle.

In operation 1410, the vehicle may identify whether the driving route of the other vehicle included in the escape message corresponds to a driving route of the vehicle based on the received message. In the example embodiment, the vehicle may identify a route along which the vehicle receiving the escape message is to move such that the other vehicle secures the driving route for traveling. Also, the vehicle may identify whether the identified route corresponds to the driving route of the vehicle.

When the identified route does not correspond to the driving route of the vehicle, the vehicle may provide route correction-related information to the user in operation 1415. The route correction-related information may include original route information, corrected route information, and information on whether to permit the route correction.

When the user permits a route correction based on the provided information in operation 1420, the vehicle may perform driving for securing a route of the other vehicle based on the corrected route in operation 1430. When the user does not permit the route correction, the vehicle may perform driving while maintaining an original route.

When the driving route of the other vehicle corresponds to the driving route of the vehicle receiving the escape message in operation 1410, the vehicle may provide information on a movement associated with the other vehicle in operation 1425. For example, the vehicle may provide the user with information indicating that the driving corresponding to the route of the other vehicle is to be performed. In the example embodiment, operation 1425 may be performed selectively.

Thereafter, in operation 1430, the vehicle may perform the driving based on the driving route. In this case, a movement may be performed based on the route corresponding to the other vehicle.

As such, even when vehicles have different driving routes, a vehicle may provide related information and correct a route based on a response of a user through a V2V message exchange, thereby performing driving with increased efficiency.

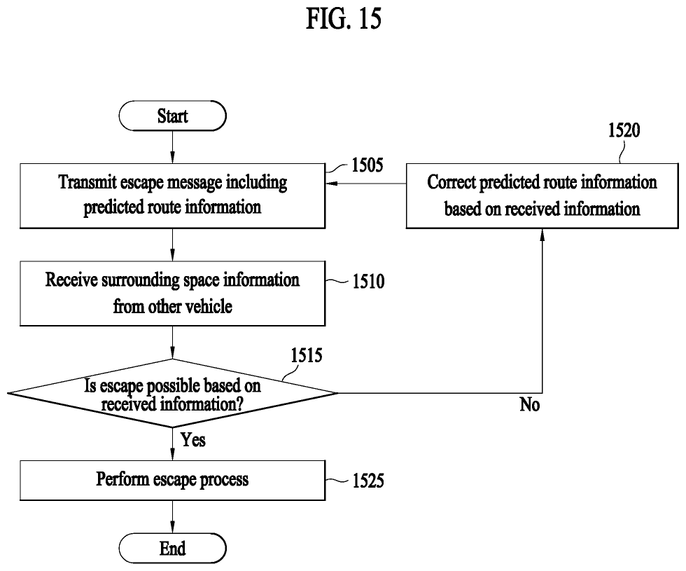

FIG. 15 is a flowchart illustrating a method of securing a route by setting another route when driving on a predicted route is unavailable according to an example embodiment.

FIG. 15 illustrates an example embodiment related to a method in which a vehicle transmits an escape message including predicted route information and when a movement is unavailable, additionally transmitting an escape message by correcting a predicted route.

In operation 1505, a vehicle may transmit an escape message including predicted route information to other vehicle.

In operation 1510, the vehicle may receive a response message including information on a surrounding space from the other vehicle receiving the escape message. The response message may include information on a movable range of the other vehicle transmitting the message. In the example embodiment, an unmovable vehicle or a vehicle that is not located on the predicted route may not transmit the response message.

In operation 1515, the vehicle may identify whether driving on the predicted route is available based on the information included in the received response message. When the driving is unavailable, the vehicle may identify other predicted route based on the received information in operation 1520, and return to operation 1505 to transmit an escape message including the corrected predicted route.

When the driving is available, the vehicle may transmit a movement request message to the other vehicle located on a driving route. When the other vehicle moves, the vehicle may perform an escape process for performing the driving on the corresponding route in operation 1525.

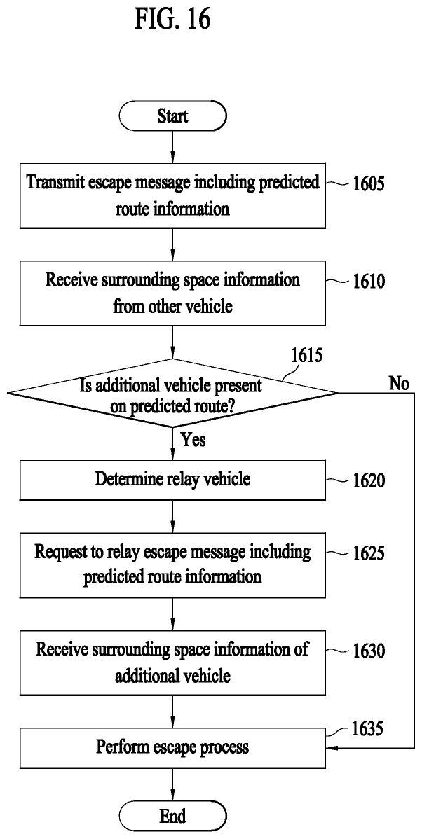

FIG. 16 is a flowchart illustrating a method of selecting a relay vehicle for message transmission according to an example embodiment.

FIG. 16 illustrates a method in which a vehicle selects a predetermined vehicle as a relay vehicle when the vehicle transmits a message so that the relay vehicle transmits the message to other vehicle.

In operation 1605, a vehicle may transmit an escape message including predicted route information. In the example embodiment, the escape message may be transmitted through a broadcast channel. Transmission power for transmitting the message may be determined as a specific value.

In operation 1610, the vehicle may receive a response message to the escape message from other vehicle. The response message may include information on a surrounding space of the other vehicle transmitting the response message. The information on the surrounding space of the other vehicle may include information on an area in which the other vehicle is possible to move for securing the predicted route.

In operation 1615, the vehicle may identify whether an additional vehicle having not transmitted the response message among other vehicles located on the predicted route is present, based on the received message. The additional vehicle may be a vehicle located outside an area in which the escape message is transmitted.

When the additional vehicle is absent, the vehicle may transmit a movement request message to the other vehicle based on the received information. Also, the vehicle may perform an escape process based on predicted route information as in operation 1635.

When the additional vehicle is present, the vehicle may determine a vehicle for relaying and transmitting the message based on the received information in operation 1620. A method to select the vehicle for relaying the message may include at least one of selecting a vehicle having a minimum Time-to-Live in relation to transmission of the escape message, selecting a vehicle located farthest from the vehicle among vehicles having transmitted the response message, and selecting a predetermined vehicle.

In operation 1625, the vehicle may request a selected relay vehicle to relay an escape message including the predicted route information. Relay request information may include information on the transmission power for transmitting a relay message.

In operation 1630, the vehicle may receive surrounding space information of the additional vehicle through the relay vehicle.

In operation 1635, the vehicle may perform an escape process based on the received information. Also, the movement request message may be transmitted to the additional vehicle through the relay vehicle.

As such, a vehicle may select a relay vehicle and transmit an escape message and a movement request message, thereby securing a driving route through message transmission between vehicles even when a plurality of vehicles are located on the driving route.

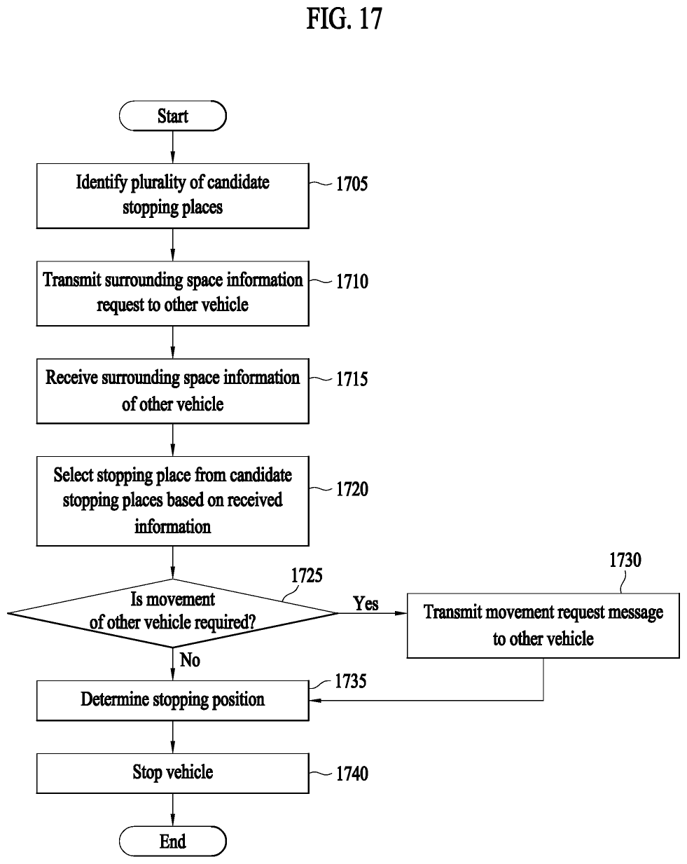

FIG. 17 is a flowchart illustrating a method of determining a vehicle stopping place according to an example embodiment.

FIG. 17 illustrates an example embodiment in which a vehicle determines a place to stop through a message exchange with other vehicle and secure the place when the vehicle is to stop.

In operation 1705, the vehicle may identify at least one candidate stopping place. In the example embodiment, the vehicle may identify a possible stopping position through a sensor and identify at least one candidate stopping place based on the possible stopping position.

In operation 1710, the vehicle may transmit a message requesting surrounding space information to other vehicle in association with a stoppage.

In operation 1715, the vehicle may receive a message about the surrounding space information from the other vehicle.

In operation 1720, the vehicle may select a stopping place from candidate stopping places based on at least one item of received information. As an example, the vehicle may select a position at which a movement of the other vehicle is minimized, to be the stopping place. As another example, the vehicle may select a position adjacent to a vehicle that is able to instruct a vehicle movement through message transmission and reception, to be the stopping place. As another example, the vehicle may select a stopping place in which more driving routes are to be secured in accordance with a movement of the other vehicle.

In operation 1725, the vehicle may identify whether a movement of the other vehicle is required, to stop in the selected stopping place. When the movement is required, the vehicle may transmit a movement request message to the other vehicle in operation 1730. The other vehicle receiving the movement request message may perform the movement for securing the stopping place.

In operation 1735, the vehicle may determine the selected place to be a stopping position.

In operation 1740, the vehicle may stop at the determined stopping position.

As such, in determining a position for stopping, a vehicle may determine a stopping position through a message exchange with other vehicle, so as to more easily secure a route when the stopped vehicle is to perform additional driving at the stopping position.

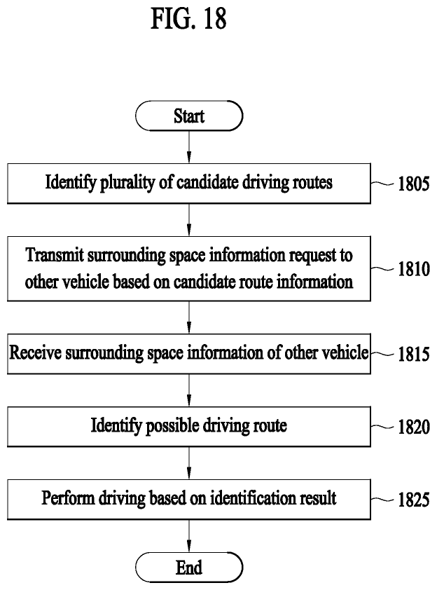

FIG. 18 is a flowchart illustrating a method of acquiring route information on a driving route and selecting one route from a plurality of routes based on the route information according to an example embodiment.

FIG. 18 illustrates an example embodiment related to a method of identifying a plurality of driving routes, transmitting escape messages to a plurality of vehicles based on candidate driving routes, receiving related information, and determining a driving route based on the received information.

In operation 1805, a vehicle may identify a plurality of candidate driving routes. The plurality of candidate driving routes may include a plurality of routes for reaching one destination.

In operation 1810, the vehicle may transmit a message requesting a space information message to other vehicle based on candidate route information. In the example embodiment, the space information request message may include candidate route information. Also, one space information request message may include at least one item of candidate route information.

In operation 1815, the vehicle may receive a surrounding space information message of the other vehicle corresponding to the transmitted message. The surrounding space information message may include at least one of information for identifying a vehicle transmitting the corresponding message, position information of the corresponding vehicle, and information on a space in which the corresponding vehicle is possible to move.

In operation 1820, the vehicle may identify a possible driving route among routes to a destination based on the received message. In the example embodiment, the possible driving route may include at least one of a currently obtained route and a route to be obtained through a movement of the other vehicle. Also, in the example embodiment, the vehicle may identify the possible driving route based on a distance of a route to the destination and a number of times that the other vehicle is to perform a movement for securing the route.

In operation 1825, the vehicle may perform driving based on an identification result. When a movement of other vehicle is required to secure a route during the driving, the vehicle may transmit a movement request message to the other vehicle.

As such, a vehicle may receive information on other vehicles located on a plurality of candidate routes in advance, select a route based on the information, and perform driving on the route, thereby reaching a destination with less manipulating the vehicle or other vehicles.

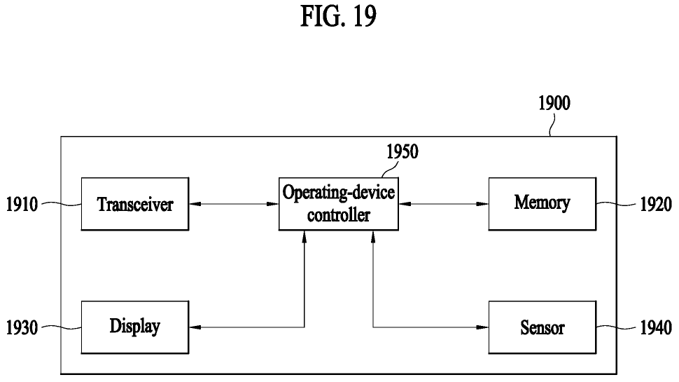

FIG. 19 is a diagram illustrating an operating device according to an example embodiment.

FIG. 19 illustrates a operating device 1900.

The operating device 1900 may include at least one of a transceiver 1910, a memory 1920, a display 1930, a sensor 1940, and a controller 1950. Depending on examples, at least one of the transceiver 1910, the memory 1920, the display 1930, and the sensor 1940 may be located external to the operating device 1900 and controlled through communication with the controller 1950.

The transceiver 1910 may perform communication with an external node. For example, an escape message and a movement request message may be transmitted through the transceiver 1910. Also, a response message may be received through the transceiver 1910 in response thereto.

The memory 1920 may include at least one of information required for an operation of the operating device 1900 and information transmitted and received through the transceiver 1910.

The display 1930 may display information associated with an operation of the operating device 1900. In the example embodiment, to provide route information or inquire about whether a user is to agree, corresponding information may be displayed on the display. Also, the display may include a touch screen and receive the corresponding information through a touch input.

The sensor 1940 may identify at least one of position information of the vehicle and information on a surrounding space of the vehicle. For example, the sensor 1940 may include a device for acquiring the position information through communication with a GPS. Also, the sensor 1940 may include a sensor device for acquiring the information on the surrounding space.

The controller 1950 may control each component of the operating device 1900 to perform an operation of the operating device of the example embodiment. In the example embodiment, a method described as an operation of a vehicle may be understood as an operation of the operating device 1900.

According to example embodiments, it is possible to provide a method and apparatus for requesting a movement of other vehicle located on a route through V2V communication and securing a driving route accordingly. When other vehicle is located on a route, the method and apparatus may allow a vehicle to secure the route by sending a movement request to the other vehicle, thereby providing enhanced usability.

The above description is merely illustrative of the technical idea of the present disclosure, and those skilled in the art to which the present disclosure pertains may make various modifications and changes without departing from the essential quality of the present disclosure. Accordingly, the embodiments disclosed herein are not intended to limit the technical spirit of the present disclosure but to describe the present disclosure, and the scope of the technical spirit of the present disclosure is not limited by these embodiments. The scope of protection of the present disclosure should be interpreted by the following claims, and all technical ideas that fall within the scope of equivalents thereof should be construed as being included in the scope of the present disclosure.

What is claimed is:

1. A method of controlling a vehicle, the method comprising:
identifying a driving route;
identifying whether other vehicle is on the driving route;
transmitting a first request message based on information on the driving route;
identifying whether a first response message to the first request message is received from the other vehicle; and
transmitting, when the first response message is received, a second request message requesting a movement based on the information on the driving route, to the other vehicle based on the first response message.

2. The method of claim 1, wherein the first request message is transmitted on a channel for broadcast, and
wherein the second request message is transmitted on a channel for vehicle-to-vehicle (V2V) communication.

3. The method of claim 1, further comprising:
controlling driving of the vehicle based on the driving route when the other vehicle moves in response to the second request message; and
transmitting a third request message requesting a movement to an original position, to the other vehicle in accordance with the driving.

4. The method of claim 1, wherein the first request message includes at least one of driving route information, information for identifying the vehicle, position information of the vehicle, size information of the vehicle, and direction information of the vehicle.

5. The method of claim 1, wherein the first response message includes at least one of position information of the other vehicle and information associated with a movable range of the other vehicle and
wherein the information associated with the movable range is identified based on at least one of map information and information acquired through a sensor of the other vehicle.

6. The method of claim 1, wherein a communication mode of the other vehicle is changed based on the first request message.

7. The method of claim 1, wherein the first response message includes a plurality of first response messages which is received from a plurality of other vehicles and
wherein the second request message is transmitted sequentially to the plurality of other vehicles based on a movement order identified based on the received first response messages.

8. The method of claim 1, further comprising:
identifying other driving route when the first response message is not received, or when the driving route is not secured based on information included in the received first response message; and
transmitting a third request message based on the identified other driving route.

9. The method of claim 1, further comprising:
identifying candidate places for stopping;
transmitting a fourth request message requesting information to other vehicle associated with each of the candidate places based on the candidate places;
receiving a second response message to the fourth request message from the other vehicle associated with each of the candidate places; and
moving to a position corresponding to a stopping place selected from the candidate places based on the received second response message.

10. The method of claim 1, further comprising:
transmitting a fifth request message requesting information on other vehicle,
wherein the driving route is determined based on a third response message received in response to the fifth request message.

11. The method of claim 1, further comprising:
identifying a vehicle for relaying a message based on the other vehicle located on the driving route,
wherein the first request message is transmitted to the other vehicle through the identified vehicle for relaying the message.

12. The method of claim 1, further comprising:
modifying the driving route when the first response message is not received and transmitting a sixth request message based on the corrected driving route.

13. The method of claim 1, wherein the first response message includes identification information of the other vehicle and the second request message is transmitted based on the identification information of the other vehicle.

14. A vehicle comprising:
a transceiver; and
a controller configured to control the transceiver, identify a driving route, identify whether other vehicle is on the driving route, transmit a first request message based on information on the driving route, identify whether a first response message to the first request message is received from the other vehicle, and transmit a second request message requesting a movement based on the driving route, to the other vehicle based on the first response message when the first response message is received.

15. A non-volatile storage medium comprising instructions to execute the method of claim 1.
